(19) United States
(12) Patent Application Publication
(10) Pub. No.: US 2007/0049257 A1
(43) Pub. Date: Mar. 1, 2007

(54) Processing calls in a selective call radio and methods thereof

(76) Inventors: Swetal A. Patel, Coral Springs, FL (US); Jyh-Han Lin, Parkland, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/218,122

(22) Filed: Sep. 1, 2005

(51) Int. Cl. H04Q 7/38; H04Q 7/22; H04M 3/00; H04M 3/42

(52) U.S. Cl. 455/414.1; 455/418

(57) ABSTRACT

A selective call radio (100) has a radio frequency transceiver (102), and a processor (104) for controlling operations of the transceiver. The processor is programmed to cause (202) the transceiver to receive a third party call while the SCR is actively engaged in an end user call, and respond (203) to the third party call according to a call response profile defined by an end user of the SCR.

### FIELD OF THE INVENTION

This invention relates generally to call processing, and more particularly to processing calls in a selective call radio and methods thereof.

### BACKGROUND OF THE INVENTION

When calling someone on a mobile phone or like communication device it is possible that the calling party will experience a busy signal if the recipient of the call is engaged on another call, or no response at all. Unfortunately there's no way of knowing with clarity why the party being called is not responding.

### SUMMARY OF THE INVENTION

Embodiments in accordance with the invention provide an apparatus and method for processing calls in a selective call radio.

In a first embodiment of the present invention, a selective call radio (SCR) has a computer-readable storage medium. The storage medium includes computer instructions for receiving a third party call while the SCR is actively engaged in an end user call, and responding to the third party call according to a call response profile defined by an end user of the SCR.

In a second embodiment of the present invention, a selective call radio (SCR) operates according to a method having the steps of receiving a third party call while the SCR is actively engaged in an end user call, and responding to the third party call according to a call response profile defined by an end user of the SCR.

In a third embodiment of the present invention, a selective call radio (SCR) has a radio frequency (RF) transceiver, a display for conveying images to an end user of the SCR, an audio system for exchanging audible signals with the end user, and a processor for controlling operations of the transceiver. The processor is programmed to cause the transceiver to receive a third party call while the SCR is actively engaged in an end user call, and respond to the third party call according to a call response profile defined by an end user of the SCR.

### BRIEF DESCRIPTION OF THE DRAWINGS

FIG. 1 is a block diagram of a selective call radio (SCR) in accordance with an embodiment of the present invention.

FIG. 2 is a flow chart depicting a method operating in the SCR in accordance with an embodiment of the present invention.

### DETAILED DESCRIPTION OF THE DRAWINGS

While the specification concludes with claims defining the features of embodiments of the invention that are regarded as novel, it is believed that the embodiments of the invention will be better understood from a consideration of the following description in conjunction with the figures, in which like reference numerals are carried forward.

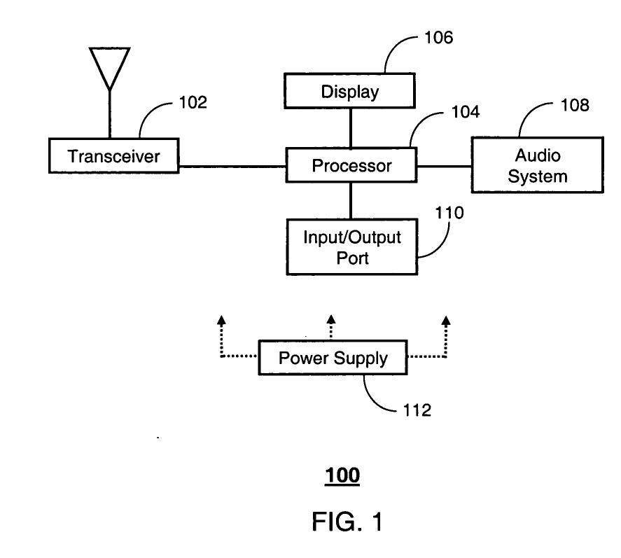

FIG. 1 is a block diagram of a selective call radio (SCR) 100 in accordance with an embodiment of the present invention. The SCR 106 comprises conventional technology such an RF transceiver 102, a display 106 for conveying images to an end user of the SCR 100, input/output port 110 for coupling with a conventional keypad of the SCR 100 and conventional accessories, an audio system 108 for exchanging audible signals with the end user, a power supply 112 for supplying power to the elements of the SCR 100, and a processor 104 such as a DSP (Digital Signal Processor) and/or microprocessor for controlling operations thereof.

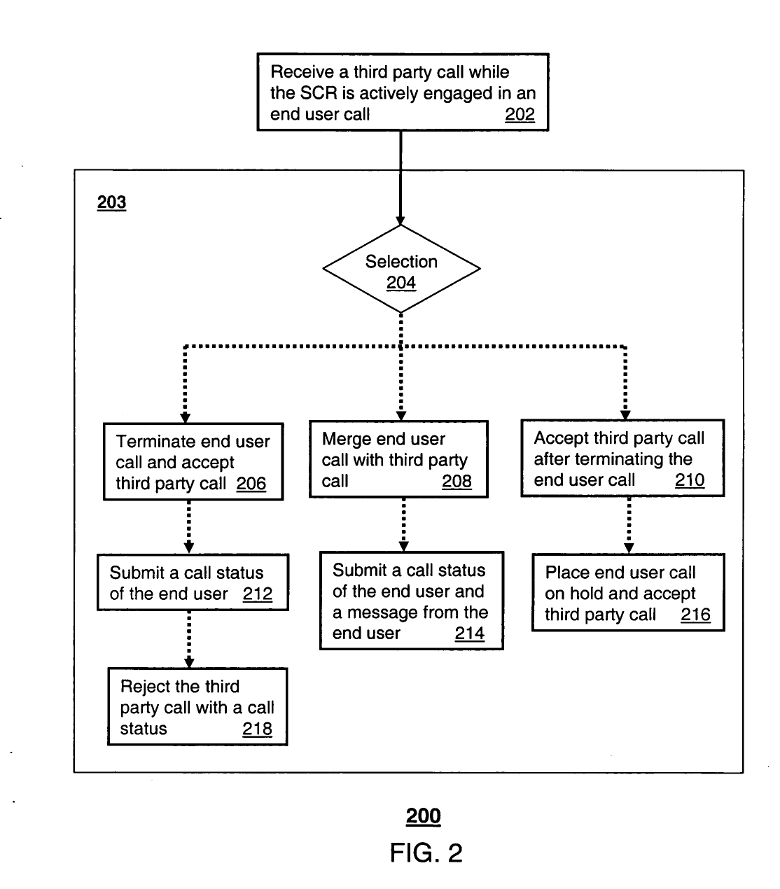

The SCR 100 exchanges wireless messages with a conventional communication system such as a cellular network supporting half-duplex and/or full duplex voice and data messaging. FIG. 2 is a flow chart depicting a method 200 operating in the SCR 100 in accordance with an embodiment of the present invention. In method 200 the processor 104 is programmed to receive in step 202 a third party call while the SCR 100 is actively engaged in an end user call. The end user call can be a half-duplex push-to-talk (PTT) call and/or a full-duplex voice call with another caller or a group call of two or more parties. The third party call is submitted by a third party caller attempting to communicate with the end user of the SCR 100 using PTT or full-duplex voice messaging. In step 203 the processor 104 responds to the third party call according to a call response profile defined by an end user of the SCR 100.

Step 203 can be accomplished by any number of embodiments one of which is demonstrated in FIG. 2. In this embodiment, the processor 104 is programmed in step 204 to select from at least one among a group of options in response to instructions from the end user of the SCR 100 and/or the call response profile. To assist in the selection process, the call response profile can include, but is not limited to, selection criteria such as one or more call termination and acceptance options with associated priority settings each corresponding to a caller ID, one or more call status response options with associated caller IDs, immediate call acceptance for one or more emergency numbers, and/or one or more call rejection options according to caller ID.

The end user of the SCR 100 and/or the network operator providing wireless services to the end user can define the call response profile with suitable selection criteria such as described above. The call response profile can be downloaded into the SCR 100 by any conventional means such as, for example, tethering the SCR 100 to a cradle coupled to a computer, over-the-air programming by the network operator or by a local area network (e.g., Bluetooth, IEEE802.11b), and/or manual entry by the end user using a conventional UI (User Interface) of the SCR 100.

In the present illustration a call response option can be selected in step 204 according to a caller ID of the third party call and associated priority as defined in the call response profile. A few options are shown in FIG. 2 that are selectable according to said caller ID and priority. For example, in step 206 the end user call can be immediately terminated and followed by an acceptance of the third party call. This option can be automated by way of the call response profile established by the end user of the SCR 100 along with instructions provided by the end user.

That is, the end user can define in the call response profile a caller ID and priority such that for the current third party call the processor 104 automatically terminates the current end user call and accepts the third party call. An example, of this could be the call response profile having a priority and associated caller ID to accept calls from the end user's manager immediately upon receipt. Alternatively, the end user can define one or more emergency numbers in the call response profile. In this embodiment, an emergency number can be represented by the caller ID of the third party call and/or, alternatively a code supplied by the third party caller such as “*#” during the third party call, or by way of an SMS (Short Messaging System) page, or other means of communication with the SCR 100 for conveying an emergency status.

In an alternative embodiment, step 206 can be modified to perform the function of step 216. That is, the end user call can be placed on hold, while the end user accepts the third party call. In yet another embodiment, the third party call can be merged in step 208 with the current end user call, which may be a multiparty call (i.e., a group call). As before, the merging process can occur in response to manual instructions of the end user in combination with settings in the call response profile.

There may be instances, however, where immediate termination of the end user call is not necessary step 210 can be selected. In this embodiment, the third party caller may simply give up trying to engage with the end user after several call tries. However, under instructions of the end user or call response profile, the processor 104 can be programmed to automatically establish a call back with the third party caller after the end user call has been terminated. This step can be supplemented by any one of steps 212, 214, or 218.

In the preceding example the third party caller may have no idea why the end user is not answering the call. With the addition of step 212 and instructions from the end user or the call response profile, a call status of the end user can be submitted to the third party caller by way of, for example, a control channel of the communication system. The call status can be packet data representing a page submitted to the third party caller that includes information relating to the end user call such as, “Sam Doe is presently on a call with Joe Doe”, or “Sam Doe is presently on a CORE group call”, and so on. Alternatively, in step 214 the call status can be represented by a message submitted in part by the end user such as, “Sam Doe is presently on a call with Joe Doe. He will call you as soon as he hang's up”, or “Sam Does on a call with the CORE group, would you like to join?”, or “Sam Doe is presently on a call with Joe Doe. He will call you back shortly”, or “Sam Doe is presently on a call with Joe Doe. Please hold and he will answer your call shortly”, and so on. Portions of these messages can be supplied in part by the end user with a keypad of the SCR 100 and in response to settings of the call response profile. From these responses, the third party call can be accepted and placed on hold while waiting for the end user, or the third party call can be rejected as in step 218 with an indication from the end user as to what s/he intends to do.

It should be evident by now that the present invention can be realized in hardware, software, or combinations thereof. Additionally, the present invention can be embedded in a computer program of the SCR 100, which comprises all the features enabling the implementation of the methods described herein, and which enables said devices to carry out these methods. A computer program in the present context means any expression, in any language, code or notation, of a set of instructions intended to cause a system having an information processing capability to perform a particular function either directly or after either or both of the following: a) conversion to another language, code or notation; b) reproduction in a different material form. Additionally, a computer program can be implemented in hardware as a state machine without conventional machine code as is typically used by CISC (Complex Instruction Set Computers) and RISC (Reduced Instruction Set Computers) processors.

It should also be evident that the present invention may be used for many applications. Thus, although the description is made for particular arrangements and methods, the intent and concept of the invention is suitable and applicable to other arrangements and applications not described herein. Thus the embodiments of method 200 can in numerous ways be modified with additions thereto without departing from the spirit and scope of the invention.

Accordingly, the described embodiments ought to be construed to be merely illustrative of some of the more prominent features and applications of the invention. It should also be understood that the claims are intended to cover the structures described herein as performing the recited function and not only structural equivalents. Therefore, equivalent structures that read on the description are to be construed to be inclusive of the scope of the invention as defined in the following claims. Thus, reference should be made to the following claims, rather than to the foregoing specification, as indicating the scope of the invention.

What is claimed is:

1. In a selective call radio (SCR) a computer-readable storage medium, the storage medium comprising computer instructions for:
receiving a third party call while the SCR is actively engaged in an end user call; and
responding to the third party call according to a call response profile defined by an end user of the SCR.

2. The storage medium of claim 1, wherein the end user call is among one of a group of calls comprising a half-duplex push-to-talk call and a full-duplex voice call.

3. The storage medium of claim 1, further comprising computer instructions for accepting the third party call if according to the call response profile said call is recognized as an emergency call.

4. The storage medium of claim 1, further comprising computer instructions for selecting from at least one among a group of options in response to at least one among instructions from the end user and the call response profile, comprising:
terminating the end user call and accepting the third party call;
placing the end user call on hold and accepting the third party call;
converging the end user call with the third party call;
accepting the third party call after terminating the end user call;
submitting a call status of the end user call;
submitting a call status of the end user call with a message from the end user of the SCR; and
rejecting the third party call with a call status of the end user call.

5. The storage medium of claim 4, wherein at least one among the third party call and the end user call is a group call.

6. The storage medium of claim 1, wherein the call status corresponds to at least one among a group of status options comprising information relating to the end user call and a message from an end user of the SCR.

7. The storage medium of claim 1, wherein the call response profile includes at least one among a group of call selection criteria comprising one or more call termination and acceptance options according to a priority and corresponding caller ID, one or more call status response options according to caller ID, immediate call acceptance for one or more emergency numbers, and one or more call rejection options according to caller ID.

8. In a selective call radio (SCR), a method comprising the steps of:
receiving a third party call while the SCR is actively engaged in an end user call; and
responding to the third party call according to a call response profile defined by an end user of the SCR.

9. The method of claim 8, wherein the end user call is among one of a group of calls comprising a half-duplex push-to-talk call and a full-duplex voice call.

10. The method of claim 8, further comprising the steps of accepting the third party call if according to the call response profile said call is recognized as an emergency call.

11. The method of claim 8, further comprising the steps of selecting from at least one among a group of options in response to at least one among instructions from the end user and the call response profile, comprising:
terminating the end user call and accepting the third party call;
placing the end user call on hold and accepting the third party call;
converging the end user call with the third party call;
accepting the third party call after terminating the end user call;
submitting a call status of the end user call;
submitting a call status of the end user call with a message from the end user of the SCR; and
rejecting the third party call with a call status of the end user call.

12. The method of claim 11, wherein at least one among the third party call and the end user call is a group call.

13. The method of claim 8, wherein the call status corresponds to at least one among a group of status options comprising information relating to the end user call and a message from an end user of the SCR.

14. The method of claim 8, wherein the call response profile includes at least one among a group of call selection criteria comprising one or more call termination and acceptance options according to a priority and corresponding caller ID, one or more call status response options according to caller ID, immediate call acceptance for one or more emergency numbers, and one or more call rejection options according to caller ID.

15. A selective call radio (SCR), comprising:
a radio frequency (RF) transceiver;
a display for conveying images to an end user of the SCR;
an audio system for exchanging audible signals with the end user; and
a processor for controlling operations of the transceiver, wherein the processor is programmed to:
cause the transceiver to receive a third party call while the SCR is actively engaged in an end user call; and
respond to the third party call according to a call response profile defined by an end user of the SCR.

16. The SCR of claim 15, wherein the end user call is among one of a group of calls comprising a half-duplex push-to-talk call and a full-duplex voice call.

17. The SCR of claim 15, wherein the processor is programmed to select from at least one among a group of options in response to at least one among instructions from the end user and the call response profile, comprising:
terminating the end user call and accepting the third party call;
placing the end user call on hold and accepting the third party call;
converging the end user call with the third party call;
accepting the third party call after terminating the end user call;
submitting a call status of the end user call;
submitting a call status of the end user call with a message from the end user of the SCR; and
rejecting the third party call with a call status of the end user call.

18. The SCR of claim 17, wherein at least one among the third party call and the end user call is a group call.

19. The SCR of claim 15, wherein the call status corresponds to at least one among a group of status options comprising information relating to the end user call and a message from an end user of the SCR.

20. The SCR of claim 15, wherein the call response profile includes at least one among a group of call selection criteria comprising one or more call termination and acceptance options according to a priority and corresponding caller ID, one or more call status response options according to caller ID, immediate call acceptance for one or more emergency numbers, and one or more call rejection options according to caller ID.
